(19) United States
(12) Patent Application Publication
(10) Pub. No.: US 2015/0053615 A1
(43) Pub. Date: Feb. 26, 2015

(54) SYSTEM AND METHOD FOR WATER ENHANCEMENT AND PURIFICATION

(71) Applicant: Water for Athletics, LLC, Metairie, LA (US)

(72) Inventors: Michael J. Walet, Metairie, LA (US); Emile J. Pierre, Metairie, LA (US)

(73) Assignee: Water for Athletics, LLC, Metairie, LA (US)

(21) Appl. No.: 13/974,369

(22) Filed: Aug. 23, 2013

(51) Int. Cl. C02F 9/00; C02F 1/66; C02F 1/44; C02F 1/469; C02F 1/32; C02F 1/42

(52) U.S. Cl. CPC C02F 9/00; C02F 1/32; C02F 1/42; C02F 1/441; C02F 1/4693; C02F 1/66
USPC 210/638; 210/202

(57) ABSTRACT

A system and method for water treatment, including a pre filter for filtrating sediment and removing debris from received water; an ionization and oxidation unit for sanitizing water received from the pre filter; an ultraviolet (UV) light unit for sanitizing water received from the ionization and oxidation unit with ultraviolet (UV) light; a reverse osmosis (RO) unit including a series of membranes for removing impurities from water received from the ultraviolet (UV) light unit; a remineralization filter for reinfusing water received from the reverse osmosis (RO) unit with trace minerals and salts; and an alkalinization and ionization with integrated (UV) light filtration unit for performing an electrodialysis process on water received from the remineralization filter.

### BACKGROUND OF THE INVENTION

1. Field of the Invention

The present invention generally relates to water treatment systems and methods, and more particularly to a method and system for water treatment, enhancement, purification, and the like.

2. Discussion of the Background

In recent years, water treatment systems and methods have been developed. However, such water treatment systems and methods lack robustness with respect to water enhancement, purification, and the like.

### SUMMARY OF THE INVENTION

Therefore, there is a need for a method and system that addresses the above and other problems with conventional water treatment systems and methods. The above and other problems are addressed by the illustrative embodiments of the present invention, which provide an improved method and system for water enhancement, purification, and the like.

Accordingly, in illustrative aspects of the present invention there is provided a system and method for water treatment, including a pre filter for filtrating sediment and removing debris from received water; an ionization and oxidation unit for sanitizing water received from the pre filter; an ultraviolet (UV) light unit for sanitizing water received from the ionization and oxidation unit with ultraviolet (UV) light; a reverse osmosis (RO) unit including a series of membranes for removing impurities from water received from the ultraviolet (UV) light unit; a remineralization filter for reinfusing water received from the reverse osmosis (RO) unit with trace minerals and salts; and an alkalinization and ionization with integrated (UV) light filtration unit for performing an electrodialysis process on water received from the remineralization filter.

The pre filter is configured for filtrating the received water down to 5 microns.

The ionization and oxidation unit includes copper and titanium plates having electrical current applied thereacross and configured for dissolving copper into the water flowing across the plates with the titanium plates further oxidizing the water.

The reverse osmosis (RO) unit is configured for filtrating the received water down to 0.5 microns.

The remineralization filter includes a bank of coral calcium filters.

The alkalinization and ionization with integrated (UV) light filtration unit increases the pH from about 7.6 to a pH of about 10.5.

Still other aspects, features, and advantages of the present invention are readily apparent from the following detailed description, by illustrating a number of illustrative embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIGS. 1-6 are various views of an illustrative method and system for water enhancement, purification, and the like; and

FIGS. 7-11 further details of the illustrative method and system for water enhancement, purification, and the like of FIGS. 1-6.

### DETAILED DESCRIPTION OF THE PREFERRED EMBODIMENTS

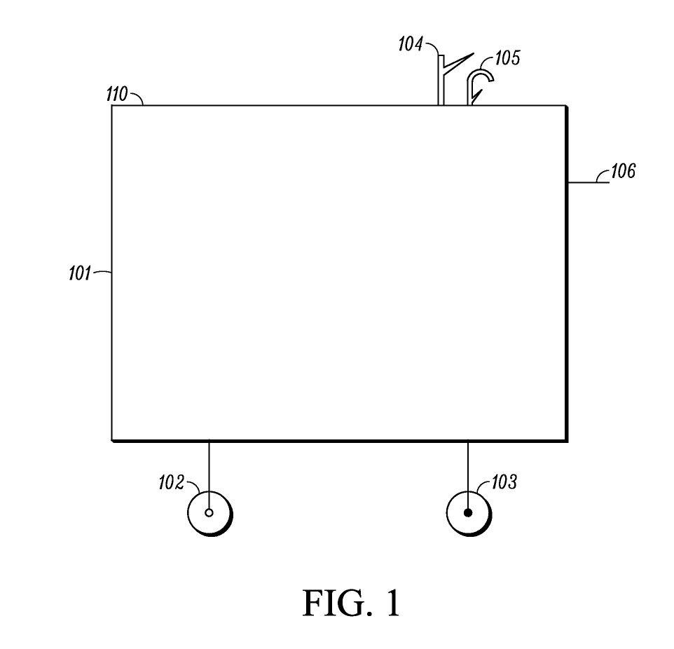

Referring now to the drawings, wherein like reference numerals designate identical or corresponding parts throughout the several views, and more particularly to FIGS. 1-6 thereof, there are illustrated various views of an illustrative method and system for water enhancement, purification, and the like, according to illustrative embodiments. In FIG. 1, the left side view of the system and method, for example, can include an enclosed cart 101 (e.g., made of aluminum, stainless steel fastened together using any known suitable fastening techniques, for example, including welding, riveting, adhesives, and the like. A top panel 110 of the cart 101 can be removal, allowing ready access to the interior components for enhanced serviceability, and the like. The top panel 110 also can be recessed to prevent water containers from inadvertently falling off, sliding off, and the like, from the cart 101.

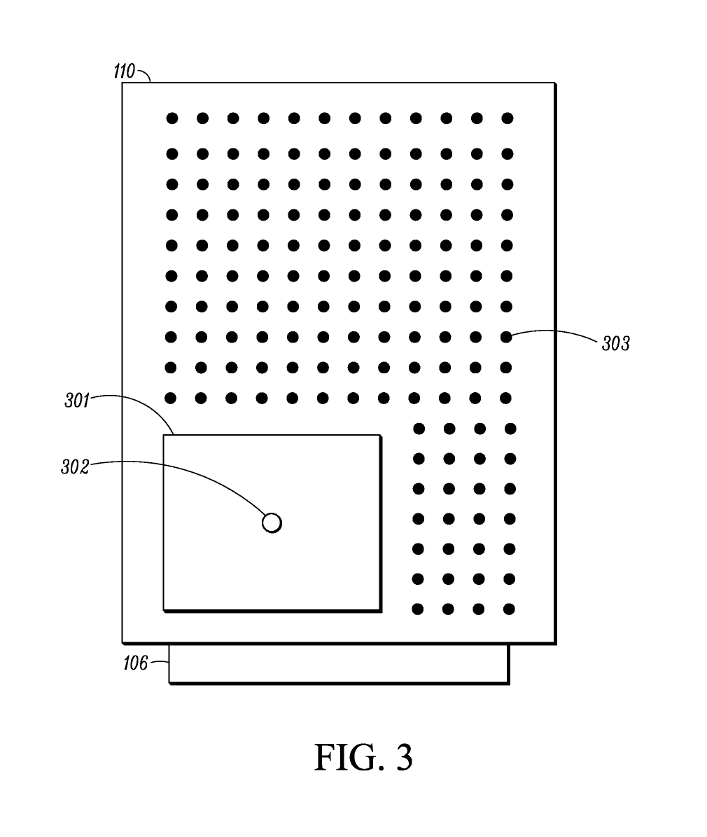

As shown in the top view of FIG. 3, a sink 301 is installed on the left or right front of unit depending upon end users preference to aide in easily rinsing, filling, removing water bottles, and the like. A drain 302 is installed in the bottom of the sink 301 and which exits the rear of the unit, for example, via a ¾ inch garden hose male fitting, and the like, and which, for example, can be readily pumped to a secondary drain or attached to a ¾ inch garden hose for drainage at desired location, and the like.

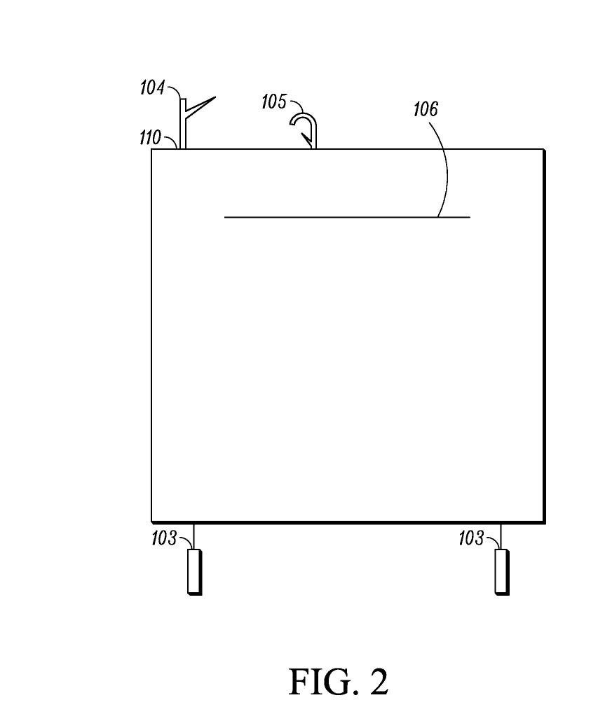

As shown in the front view of FIG. 2 and the top view of FIG. 3, two faucets 104 and 105 are installed above the sink 301. The faucet 104 is installed on the side nearest the edge left or right edge and has an integrated electronic control panel (not shown) to activate/deactivate the unit and control final pH of output water. By installing the unit 104 near the edge, the spigot of the faucet 104 can be rotated to an outside edge of the unit 101, allowing filling of large containers that are not accommodated by the sink 301. The faucet 105 is a mechanically operated faucet which controls final output of water purified by reverse osmosis and additionally sanitized using ultraviolet light, and the like.

As shown in FIGS. 1-3, the unit 101 has an oversized stainless steel handle 106 fastened on the front and four semi-rigid wheels 102 and 103. The two rear wheels 102 need not swivel, aiding in the maneuverability of the cart 101, while the two front wheels 103 can swivel, brake, and the like, to aide in preventing undesired motion of the cart 101. The top panel 110 is fitted with nylon ball transfers 303, for example, spaced two inches on center to further aid in moving the water bottles, and the like, that can be stored on top of the unit 101.

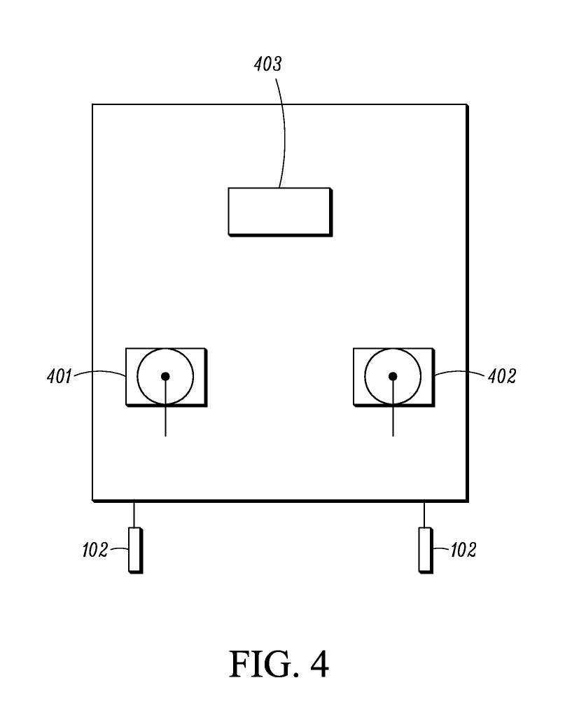

As shown in the rear view of FIG. 4, the rear of the cart 101 has two orifices 401, and 402 and, for example, a 15 AMP 120 volt ground fault interrupter outlet 403 that protects the entire unit 101 against overload, accidental electrical shocks, and the like. The orifice 401 can allow egress of, for example, a fifty foot outdoor rated 20 Amp/120 volt spring-loaded automatically retractable electrical cord. The orifice 402 can enable egress of, for example, a fifty foot spring-loaded automatically retractable ⅜ inch inner diameter rubber water hose with a ½ inch inner diameter inline spring loaded check valve followed by a quick connect connector, enabling easy swivel of water hose while decreasing kinking, as well as quick interchange of ¾ and ⅞ garden hose female fittings, and the like.

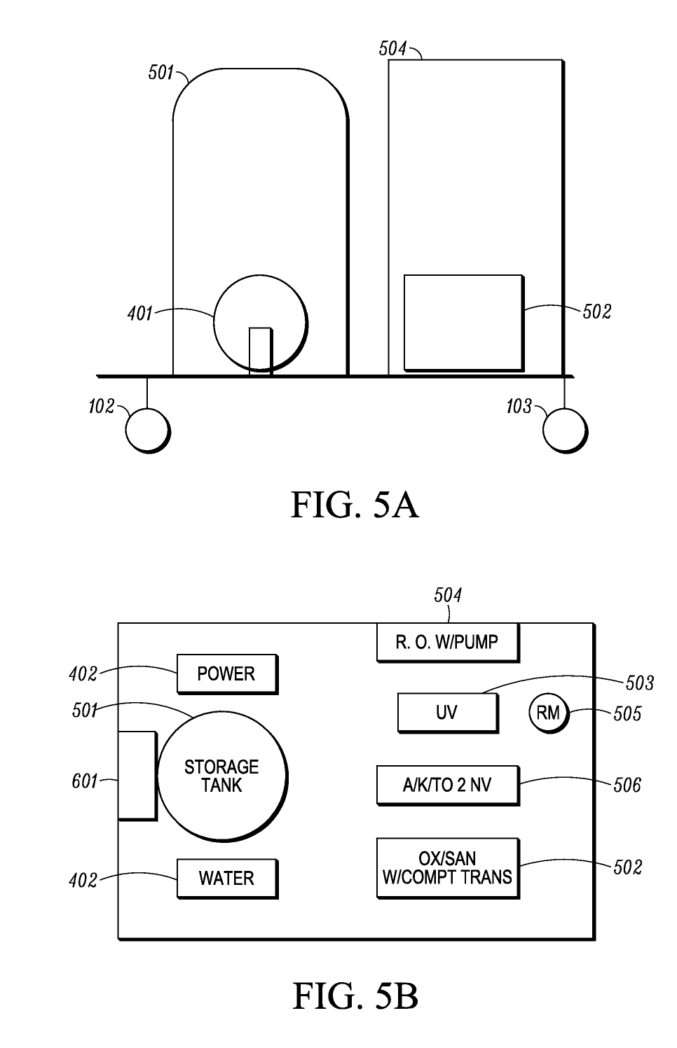

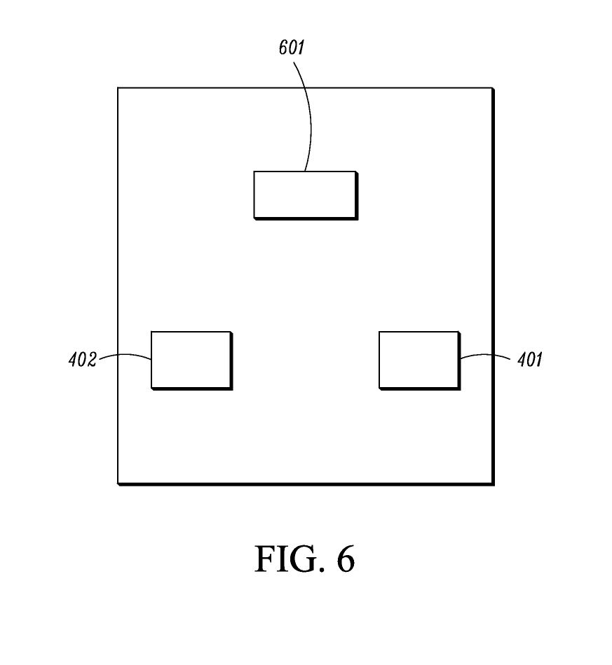

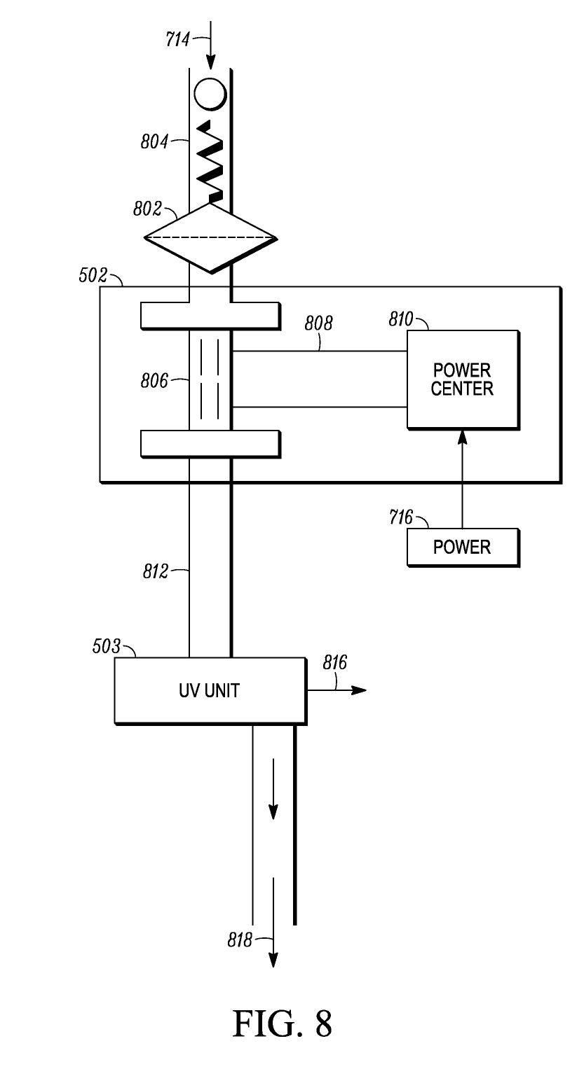

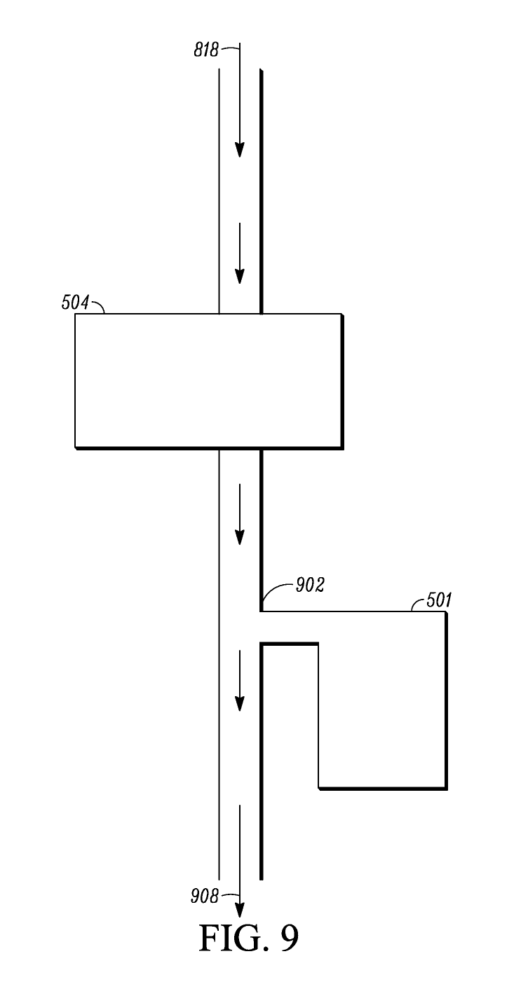

As shown in the views of FIGS. 5A-5B and FIG. 6 and described in further detail below, provided are pressurized tank 501, ionization/oxidation unit 502 (806, 808 and 810 of FIG. 8), UV system 503, reverse osmosis (RO) unit 504, remineralization filters 505, alkalinization/ionization with integrated UV filtration unit 506, and outlet 601. These units are described in further detail below.

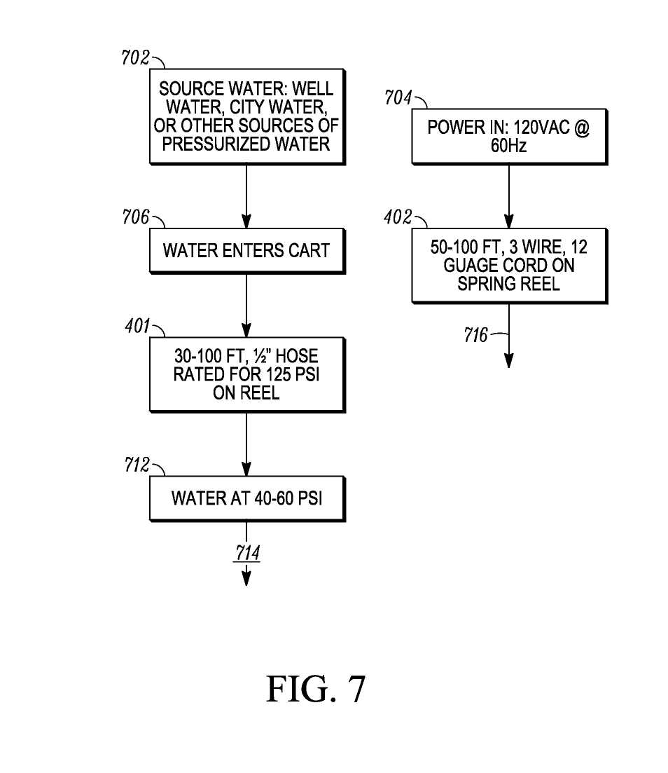

Water enters the unit 101, for example, from a pressurized water source, via the ⅜ inch inner diameter hose which is connected to ½ inch inner diameter inlet tube of the orifice 402, as further described with respect to FIG. 7. In the first stage, the water enters a pre filter 802, which filters sediment down to 5 microns—thus removing any suitable debris from the water, as further described with respect to FIG. 8.

Next, the water enters the computer-controlled ionization and oxidation chamber 502 that starts the water sanitizing process. The unit 502, for example, has platinum coated titanium plates and copper bars 808 (e.g., powered by 10 volts DC at 0.25 amps), as further described with respect to FIG. 8. The electrical current across the copper plates 808 dissolves a small amount of copper at 0.3 ppm into the water flowing across the plates 808, which acts as a natural algaecide, bactericidal agent, and the like. When current flows across the titanium plates 808, the water is further oxidized, thus killing organic organisms, and the like.

Once this stage is completed, the water enters a commercial ultraviolet (UV) light chamber 503 further sanitizing the water, as further described with respect to FIG. 8. Water then enters the reverse osmosis unit 504, where further impurities, for example, greater than 0.5 microns are removed through a series of membranes, leaving water, which is nearly free of total dissolved solids (TDS). Now, the water is naked of trace elements, toxins, and salts, all having been removed.

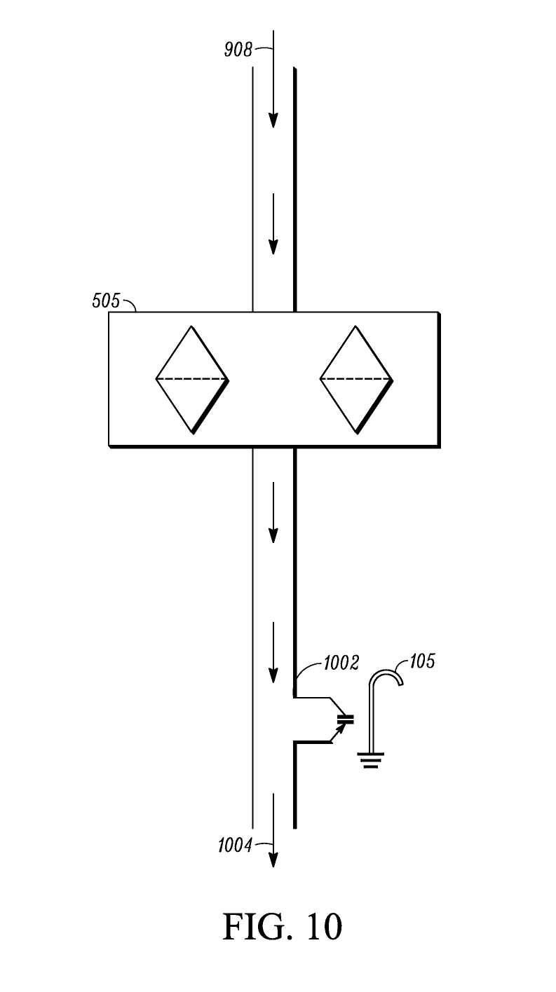

Next, the water travels through a bank of coral calcium remineralization filters 505. The filters 505 reinfuse the water with the necessary trace minerals and essential salts and add a desirable taste to the water, as further described with respect to FIG. 10. The water then proceeds to a storage tank with a pressurized bladder for ready use. The water can then be consumed by operating a mechanical valve 105, as further described with respect to FIG. 1.

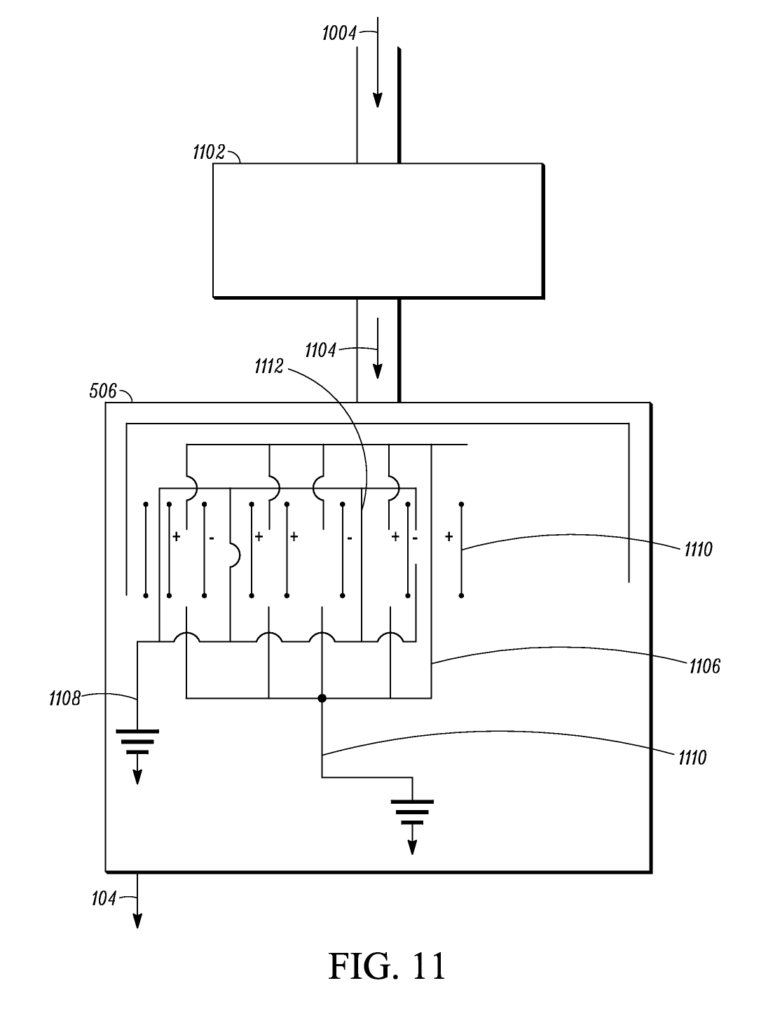

There is a second UV chamber in 506. This unit removes any potentially harmful organisms, which could accumulate in the storage tank 501. Once the calcium and essential salts are back into the water, the final stage of water processing is performed at an ionizer 1106, the alkaline and ionizing stage of the water treatment process, as further described with respect to FIG. 11.

The final stage involves an electrodialysis process, for example, initially designed by the Japanese to mitigate the effects of radiation in the post-Atomic era. Thus, the water is transformed from a pH of 7-7.6 to a pH of 10.5, as further described with respect to FIG. 11.

The water also goes through a second change through the electrolysis component of negatively charging the water (H2O goes to H+ and OH−) with an Oxidative Reduction Potential (ORP) of −800 mV. This is where the electrodialysis filter separates the water molecules based upon charge, and the electrically controlled valve 104, as further described with respect to FIG. 1, is able to control the pH/charge of the final output water for final consumption.

Accordingly, water enters the unit at step 702 of FIG. 7 from different sources, for example, including municipal water, well water, and the like. At step 704, electrical power (e.g., 120 VAC at 20 amps 60 Hertz) enters the unit via power inlet 402 (e.g., via 50 feet of 12 gauge, 3 wire on a self retractable reel). Power is then routed to an external 20 AMP ground fault interrupter 403, which has the second outlet 601 (e.g., a load on 403) on the interior of cart 101. The outlet 401 is carrying the pressurized water that enters the cart 101 at step 706 on a self retractable, coil reel 401 (e.g., 30-100 foot, ½ inch hose rated for 125 psi). At step 712, a connection point is provided where the water enters (e.g., at 40-60 psi) into a spring loaded check valve 804 (e.g., ½″) at step 714. The check valve 804 holds the water in the circuit when connecting and disconnecting from different locations for safety purposes, to prevent the machine from back flowing, and the like. A sediment filter 802 (e.g., with a 90 gpm capacity) removes sediment particles that are bigger, for example, than 5 micron in size.

Then the water proceeds, for example, to a clear PVC chamber 806 (e.g., of 1½ to 2 inches ID depending on flow demand). The chamber 806 is where electronic oxidation and ionization takes place. Insulated leads 808 (e.g., #12 AWG copper/titanium leads, plates, etc.) bring D.C. power to the chamber, which is controlled by power center 810. The power center 810 (e.g., which runs off of 12 VDC/120 VAC @1 to 2 amps) provides power for the chamber 806 via the leads 808. The power center 810, for example, uses a transformer to lower the 120 VAC to 12 VAC then rectifies the 12 VAC to DC with a suitable printed circuit board (PCB), and the like. The power center 810 also controls the voltage and current to the plates of the chamber 806 via suitable electronic circuitry, which also controls the time, the power, and the like, that is applied to the plates, and the like. Advantageously, this treats the water for algae and bacteria.

Next, via manifold 812 (e.g., which has ½ inch inside diameter rated at 150 psi and 40 gpm) the water proceeds to the UV system 503, for example, including a UV light employed for safety purposes to insure that bacteria, and the like, is totally killed. A water output 816 (e.g., ½″) can be provided for water sanitation before entering the reverse osmosis (RO) unit 504.

The reverse osmosis (RO) unit 504, which, for example, is a six stage unit with a pressure pump that runs on 120 VAC, 4 amps, 60 hertz, and with UV system 503, and is large enough to handle 600 gallon of water a day, and filtering from 200-2,000 gallons a day, if needed. Moving down the manifold 818 to a ½ inch tee 902, there is provided the pressurized tank 501 (e.g., 20 gallon), which enables the alkalinizing and ionizing unit 506 to have stored water under pressure at all suitable times. At outlet 908, everything has been removed out the water, which makes it naked water, pure H2O, toxic free, metal and mineral free (e.g., with the total dissolved solids (TDS) of the water being below 10 ppm).

From the outlet 908 (e.g., ½″, 125 psi), which is a continuation of the manifold 818, are provided a bank of remineralization filters 505 for the water (e.g., to add coral calcium to water and salts, etc.). These filters put back all suitable essential minerals the body needs, and assist in the final steps of processing the water via outlet 1004. A ½ inch tee 1002 allows filtered mineral water via mechanical faucet 105, and is also connected to the outlet 1004.

The final steps of the water processing include another UV 1102 that UV treats the water and works in a similar manner as the unit 503. Outlet 1104 leads to a chamber 1106, which is a chamber inside ionizing unit 506, and which has the electronics that converts the water and controls the power to the chamber 506, which performs the final stage of the transformation of the water into alkaline ionized water for delivery at faucet 104 of FIG. 2. Elements 1108 and 1110 are where the water is separated into acidic water 1108 (e.g., waste water) and alkaline water 1110 (e.g., water with 10.5 PH and very high negative ORP of −800 mv). For example, in order to obtain true alkaline water, the water is separated via positive charged plates 1110 and negative charged plates 1112, thus making the alkaline water negatively charged. This can be performed with computerized electronics using an electrodialysis process, and the like, to produce the ionized water (e.g., water with 10.5 PH and very high negative ORP of −800 mv).

The water is then dispensed at the faucet 104 (e.g., at 1 to 6 liters per min depending on the application demand). Advantageously, the described system and method is able to increase antioxidants of water, and boost the hydration process by providing super clean, bacteria, germ and chemical free water. The water is negatively charged, while the cells in the body are positively charge, thus immediately hydrating the cells of a body, which are lubricating body joints, wherein water is 75% of body mass. The water is also detoxifying the body due to much needed negatively charged water going into the body for hydration of the cells and joints, wherein waste water is being eliminated from the body.

Advantageously, the system and method (i) more efficiently hydrates cells as the net negatively charged water is more readily absorbed into the extracellular compartment; (ii) provides water that is pure and free from toxins; (iii) provides water that has a pleasant and refreshing taste; (iv) provides water with a net negative charge so as to create a free radical scavenger which helps to decrease cellular injury perpetrated by such molecules; and (v) provides a system and method that are readily scalable with portable platform that can provide as much water as demanded where the demand exists in an economical system thus solving the discovered problem of the short half-life of ionized water preventing its bottling on a large scale.

The above-described devices and subsystems of the illustrative embodiments can include, for example, any suitable servers, workstations, PCs, laptop computers, PDAs, Internet appliances, handheld devices, cellular telephones, wireless devices, other devices, and the like, capable of performing the processes of the illustrative embodiments. The devices and subsystems of the illustrative embodiments can communicate with each other using any suitable protocol and can be implemented using one or more programmed computer systems or devices.

One or more interface mechanisms can be used with the illustrative embodiments, including, for example, Internet access, telecommunications in any suitable form (e.g., voice, modem, and the like), wireless communications media, and the like. For example, employed communications networks or links can include one or more wireless communications networks, cellular communications networks, G3 communications networks, Public Switched Telephone Network (PSTNs), Packet Data Networks (PDNs), the Internet, intranets, a combination thereof, and the like.

It is to be understood that the devices and subsystems of the illustrative embodiments are for illustrative purposes, as many variations of the specific hardware used to implement the illustrative embodiments are possible, as will be appreciated by those skilled in the relevant art(s). For example, the functionality of one or more of the devices and subsystems of the illustrative embodiments can be implemented via one or more programmed computer systems or devices.

To implement such variations as well as other variations, a single computer system can be programmed to perform the special purpose functions of one or more of the devices and subsystems of the illustrative embodiments. On the other hand, two or more programmed computer systems or devices can be substituted for any one of the devices and subsystems of the illustrative embodiments. Accordingly, principles and advantages of distributed processing, such as redundancy, replication, and the like, also can be implemented, as desired, to increase the robustness and performance of the devices and subsystems of the illustrative embodiments.

The devices and subsystems of the illustrative embodiments can store information relating to various processes described herein. This information can be stored in one or more memories, such as a hard disk, optical disk, magneto-optical disk, RAM, and the like, of the devices and subsystems of the illustrative embodiments. One or more databases of the devices and subsystems of the illustrative embodiments can store the information used to implement the illustrative embodiments of the present inventions. The databases can be organized using data structures (e.g., records, tables, arrays, fields, graphs, trees, lists, and the like) included in one or more memories or storage devices listed herein. The processes described with respect to the illustrative embodiments can include appropriate data structures for storing data collected and/or generated by the processes of the devices and subsystems of the illustrative embodiments in one or more databases thereof.

All or a portion of the devices and subsystems of the illustrative embodiments can be conveniently implemented using one or more general purpose computer systems, microprocessors, digital signal processors, micro-controllers, and the like, programmed according to the teachings of the illustrative embodiments of the present inventions, as will be appreciated by those skilled in the computer and software arts. Appropriate software can be readily prepared by programmers of ordinary skill based on the teachings of the illustrative embodiments, as will be appreciated by those skilled in the software art. Further, the devices and subsystems of the illustrative embodiments can be implemented on the World Wide Web. In addition, the devices and subsystems of the illustrative embodiments can be implemented by the preparation of application-specific integrated circuits or by interconnecting an appropriate network of conventional component circuits, as will be appreciated by those skilled in the electrical art(s). Thus, the illustrative embodiments are not limited to any specific combination of hardware circuitry and/or software.

Stored on any one or on a combination of computer readable media, the illustrative embodiments of the present inventions can include software for controlling the devices and subsystems of the illustrative embodiments, for driving the devices and subsystems of the illustrative embodiments, for enabling the devices and subsystems of the illustrative embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the illustrative embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the illustrative embodiments of the present inventions can be distributed for better performance, reliability, cost, and the like.

As stated above, the devices and subsystems of the illustrative embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of illustrative embodiments, and implementations, the present inventions are not so limited, but rather cover various modifications, and equivalent arrangements, which fall within the purview of the appended claims.

What is claimed is:

1. A system for water treatment, comprising:
a pre filter configured for filtrating sediment and removing debris from received water;
an ionization and oxidation unit coupled to the pre filter and configured for sanitizing water received from the pre filter;
an ultraviolet (UV) light unit coupled to the ionization and oxidation unit and configured for sanitizing water received from the ionization and oxidation unit with ultraviolet (UV) light;
a reverse osmosis (RO) unit including a series of membranes and coupled to the ultraviolet (UV) light unit and configured for removing impurities from water received from the ultraviolet (UV) light unit;
a remineralization filter coupled to the reverse osmosis (RO) unit and configured for reinfusing water received from the reverse osmosis (RO) unit with trace minerals and salts; and
an alkalinization and ionization with integrated (UV) light filtration unit coupled to the remineralization filter and configured for performing an electrodialysis process on water received from the remineralization filter.

2. The system of claim 1, wherein the pre filter is configured for filtrating the received water down to 5 microns.

3. The system of claim 1, wherein the ionization and oxidation unit includes copper and titanium plates having electrical current applied thereacross and configured for dissolving copper into the water flowing across the plates with the titanium plates further oxidizing the water.

4. The system of claim 1, wherein the reverse osmosis (RO) unit is configured for filtrating the received water down to 0.5 microns.

5. The system of claim 1, wherein the remineralization filter includes a bank of coral calcium filters.

6. The system of claim 1, wherein the alkalinization and ionization with integrated (UV) light filtration unit increases the pH from about 7.6 to a pH of about 10.5.

7. A method for water treatment, comprising:
filtrating sediment and removing debris from received water with a pre filter;
sanitizing water received from the pre filter with an ionization and oxidation unit coupled to the pre filter;
sanitizing water received from the ionization and oxidation unit with ultraviolet (UV) light with an ultraviolet (UV) light unit coupled to the ionization and oxidation unit;
removing impurities from water received from the ultraviolet (UV) light unit with a reverse osmosis (RO) unit including a series of membranes and coupled to the ultraviolet (UV) light unit;
reinfusing water received from the reverse osmosis (RO) unit with trace minerals and salts with a remineralization filter coupled to the reverse osmosis (RO) unit; and
performing an electrodialysis process on water received from the remineralization filter with an alkalinization and ionization with integrated (UV) light filtration unit coupled to the remineralization filter.

8. The method of claim 7, wherein the pre filter is configured for filtrating the received water down to 5 microns.

9. The method of claim 7, wherein the ionization and oxidation unit includes copper and titanium plates having electrical current applied thereacross and configured for dissolving copper into the water flowing across the plates with the titanium plates further oxidizing the water.

10. The method of claim 7, wherein the reverse osmosis (RO) unit is configured for filtrating the received water down to 0.5 microns.

11. The method of claim 7, wherein the remineralization filter includes a bank of coral calcium filters.

12. The method of claim 7, wherein the alkalinization and ionization with integrated (UV) light filtration unit increases the pH from about 7.6 to a pH of about 10.5.
